(19) United States
(12) Patent Application Publication
(10) Pub. No.: US 2020/0274239 A1
(43) Pub. Date: Aug. 27, 2020

(54) ELECTRONIC APPARATUS

(71) Applicant: LENOVO (SINGAPORE) PTE. LTD., Singapore (SG)

(72) Inventors: Masayuki Amano, YOKOHAMA (JP); Sara Akiyama, YOKOHAMA (JP); Osamu Yamamoto, YOKOHAMA (JP)

(73) Assignee: LENOVO (SINGAPORE) PTE. LTD., SINGAPORE (SG)

(21) Appl. No.: 16/410,836

(22) Filed: May 13, 2019

(30) Foreign Application Priority Data
Feb. 27, 2019 (JP) 2019034883

(51) Int. Cl. H01Q 1/52; H01Q 1/22; H04R 1/02; H04R 1/24; H04R 3/14

(52) U.S. Cl. CPC H01Q 1/521; H01Q 1/2266; H04R 3/14; H04R 1/24; H04R 1/025

(57) ABSTRACT

An electronic apparatus has a main body chassis, first antennas, second antennas, high pitched sound speakers, low pitched sound speakers, and speaker antenna boxes provided inside the main body chassis. Each of the speaker antenna boxes includes a part of the first antenna, a part of the second antenna, the high pitched sound speaker, and the low pitched sound speaker. Inside each of the speaker antenna boxes, the low pitched sound speaker is placed between the first antenna and the second antenna, thus providing an electromagnetic shield between the first antenna and the second antenna. Each of the speaker antenna boxes has an L-shape and is provided at a place that includes a corner section. The first antennas are provided along side walls and the second antennas are provided along a front wall.

### FIELD OF THE INVENTION

The present invention relates to an electronic apparatus provided with antennas and speakers.

### BACKGROUND OF THE INVENTION

An electronic apparatus, such as a notebook type personal computer (laptop PC), has various types of wireless communication antennas, including a WWAN (Wireless Wide Area Network) and a WLAN (Wireless Local Area Network) (refer to, for example, Japanese Unexamined Patent Application Publication No. 2013-162413). Further, such an electronic apparatus includes speakers for outputting music, sound and the like (refer to, for example, Japanese Unexamined Patent Application Publication No. 2014-13970).

A laptop PC has a main body chassis which includes a motherboard, a keyboard and the like, and a display chassis which can be opened and closed by hinges with respect to the main body chassis. In some laptop PCs, antennas and speakers are provided in the display chassis.

### SUMMARY OF THE INVENTION

In order to be compatible with a plurality of communication uses, such as the WWAN and the WLAN, four or more antennas, for example, are provided in some cases. The antennas are desirably adapted to secure distance away from each other so as to avoid interference. Whereas it is easy to make an antenna thinner, the antenna is required to be placed facing a radio wave transparent material. In addition, an antenna desirably secures stable ground and stable electromagnetic wave shielding capability against other electronic components.

In some cases, a speaker for high pitched sound and a speaker for low pitched sound are provided, taking sound quality into account, and are provided on left and right sides to reproduce stereo sound. In other words, a laptop PC is provided with four speakers in some cases. Among the speakers, a speaker for low pitched sound is desirably adapted to secure a large hollow section that functions as a back chamber.

The chassis of an electronic apparatus described above has been rapidly becoming smaller and thinner. Especially in the case of a laptop PC, the frame body thereof is becoming narrower due to a so-called trend toward larger screen and narrower bezel. This is making it difficult to provide antennas and speakers in a display chassis. Hence, providing the antennas and the speakers in a main body chassis has been discussed.

However, it is also difficult to secure an adequate space for providing antennas and speakers in a main body chassis, especially for securing a space section of the back chamber of speakers while securing spacing distances among a plurality of antennas at the same time.

Further, if four antennas and four speakers are provided in a laptop PC, then the electrical connection among the antennas and the speakers complicates the manufacturing assembly process of the laptop PC.

Thus, it has been desired for the above-described electronic apparatus to be configured to secure communication quality and high sound quality while efficiently placing antennas and speakers in a chassis at the same time.

The present invention has been made with a view toward the problems with the above-described prior art, and an object of the present invention is to provide an electronic apparatus which enables antennas and speakers to be efficiently placed.

To solve the problems and to fulfill the object described above, an electronic apparatus according to the first aspect of the present invention includes: a chassis; a box provided inside the chassis; a first speaker constituted of a part of the space of the box; a first antenna formed on an outer surface of the box; and a second antenna formed on the outer surface of the box, wherein, in the box, the first speaker is placed between the first antenna and the second antenna to provide an electromagnetic shield between the first antenna and the second antenna.

The chassis may have a flat shape and have a substantially rectangular shape in a planar view, the box may have a substantially L-shape in a planar view and be provided at a place that includes a corner of the chassis, the first antenna may be provided along a first side that forms the corner, and the second antenna may be provided along a second side that forms the corner.

The electronic apparatus may further include a second speaker for outputting high pitched sound, which is constituted of a part of the space of the box, the first speaker may be for outputting low pitched sound, and the first antenna may be placed between the first speaker and the second speaker in the box.

The outer surface of the box, the first antenna and the second antenna may be provided along the outer edge of the chassis, and a shielding member formed of a material configured to shield electromagnetic wave noise may be provided on the inner surface of the box.

The chassis may include a flat plate and a turn-back plate which is integrally connected with an end portion of the flat plate and which is inclined inward, wherein a part of the box may be in the corner section between the flat plate and the turn-back plate.

The chassis may have a flat plate constituting a part of the chassis, a turn-back plate which is integrally connected with an end portion of the flat plate and which is inclined inward, and an antenna element which is a part of the first antenna or the second antenna and which is provided at a place that includes the turn-back plate, wherein the area surrounding the antenna element may be constituted of a radio wave transparent material.

Further, an electronic apparatus according to the second aspect of the present invention includes: a chassis; a speaker provided on an edge of the chassis; a first antenna provided on the edge of the chassis; and a second antenna provided on the edge of the chassis, wherein the speaker is placed between the first antenna and the second antenna to provide an electromagnetic shield between the first antenna and the second antenna.

Further, an electronic apparatus according to the third aspect of the present invention has: a chassis; a flat plate constituting a part of the chassis, a turn-back plate which is integrally connected with an end portion of the flat plate and which is inclined inward, and an antenna element which is provided at a place that includes the turn-back plate, wherein the area surrounding the antenna element is constituted of a radio wave transparent material.

The electronic apparatus may include a box provided in the chassis, wherein the box may have an interposition section, which is in a corner section between the flat plate and the turn-back plate, and a connection terminal provided on the interposition section, and the antenna element and the connection terminal may be electrically connected.

According to the above-described aspects of the present invention, antennas and speakers can be efficiently placed in a chassis of an electronic apparatus.

### BRIEF DESCRIPTION OF THE DRAWINGS

FIG. 1 is a plan view of an electronic apparatus according to an embodiment;

FIG. 2 is a bottom view schematically illustrating the internal configuration of a main body chassis;

FIG. 3 is an exploded perspective view of an upper cover and speaker antenna boxes observed from the rear surface;

FIG. 4 is a perspective view of a speaker antenna box;

FIG. 5 is an exploded perspective view of the speaker antenna box;

FIG. 6 is a schematic sectional view of the main body chassis taken along line VI-VI in FIG. 2;

FIG. 7 is a schematic sectional view of the main body chassis taken along line VII-VII in FIG. 2; and

FIG. 8 is a schematic plan view illustrating a modification example of the speaker antenna box.

### DETAILED DESCRIPTION OF THE INVENTION

The following will describe in detail an embodiment of an electronic apparatus according to the present invention with reference to the accompanying drawings. The present invention is not limited by the embodiment.

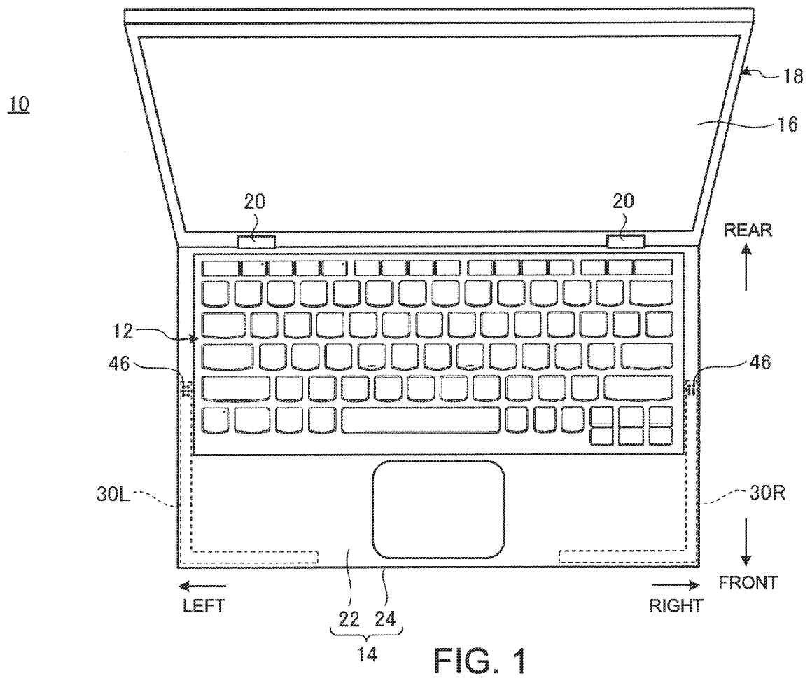

FIG. 1 is a plan view of an electronic apparatus 10 according to an embodiment. In the present embodiment, a laptop PC will be taken as an example of the electronic apparatus 10. The electronic apparatus 10 may alternatively be a desktop PC, a tablet PC or the like.

As illustrated in FIG. 1, the electronic apparatus 10 includes a main body chassis 14 having a keyboard device 12, and a display chassis 18 having a display device 16. The display chassis 18 is pivotably connected through a pair of left and right hinges 20, 20 with respect to the rear edge of the main body chassis 14. The display device 16 is, for example, a liquid crystal display. The hinges 20 are placed along a rear wall 22d.

FIG. 1 is a diagram illustrating the electronic apparatus 10 observed from above, in which the display chassis 18 has been opened from the main body chassis 14 through the hinges 20 so as to be set in a ready mode. Hereafter, the direction in which the display device 16 of the electronic apparatus 10 set in the ready mode illustrated in FIG. 1 is visually recognized from the front is defined as the reference, and in relation to the main body chassis 14, the near side will be referred to as the front, the back side as the rear, the direction of thickness as top and bottom, and the direction of width as left and right. Further, regarding the main body chassis 14 and the components installed thereto, the side closer to the central side relative to an outer peripheral side will be referred to as the inner side, and the side closer to the outer peripheral side relative to the central side will be referred to as the outer side in a state in which the main body chassis 14 is seen in a planar view. These directions are used for descriptive convenience. Therefore, depending on the placement, mounting attitude or the like of each component in the product, the vertical direction or the lateral direction mentioned above may be reversed.

The main body chassis 14 is a thin box-like chassis formed of an upper cover 22 and a lower cover 24. The main body chassis 14 has a flat shape and is substantially rectangular in a planar view. The upper cover 22 is a plate-like member constituting the upper surface and the four peripheral side surfaces of the main body chassis 14. The lower cover 24 is a plate-like member constituting the bottom surface of the main body chassis 14.

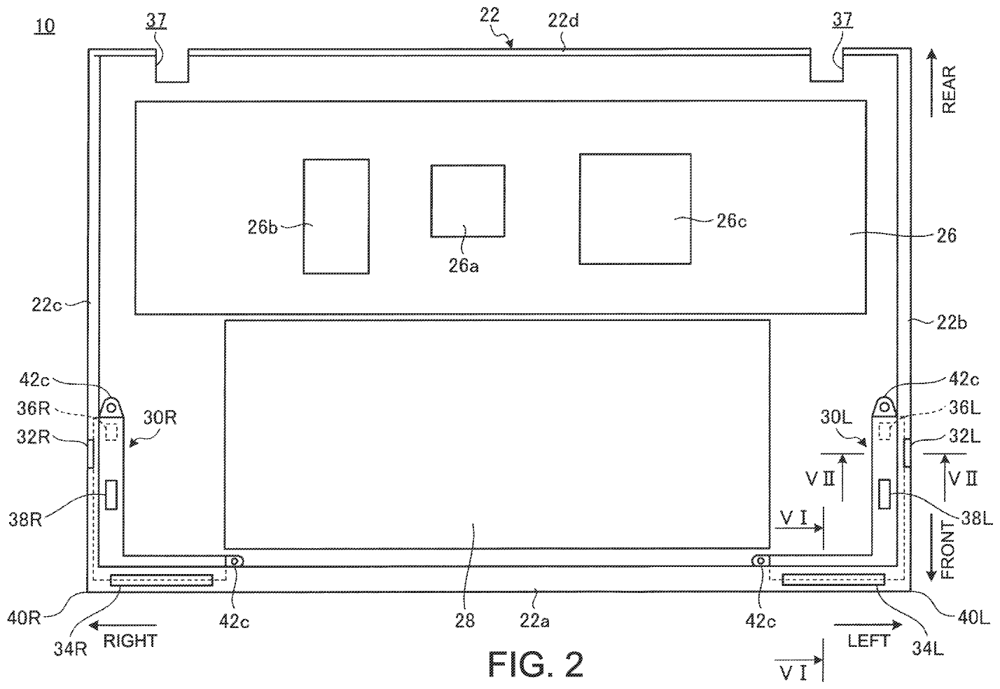

FIG. 2 is a bottom view schematically illustrating the internal configuration of the main body chassis 14, the inside of the main body chassis 14 being viewed from the inner surface side of the upper cover 22, the lower cover 24 having been removed.

As illustrated in FIG. 2, an electronic circuit board 26, a battery device 28, and a pair of left and right speaker antenna boxes 30L, 30R are housed in the main body chassis 14. Further, the electronic apparatus 10 has antennas (second antennas) 32L, 32R, antennas (first antennas) 34L, 34R, a pair of left and right high pitched sound speakers 36L, 36R, and a pair of left and right low pitched sound speakers 38L, 38R. Hereafter, the speaker antenna boxes 30L, 30R will be representatively referred to as the speaker antenna box 30, the antennas 32L and 32R will be representatively referred to as the antenna 32, the antennas 34L and 34R will be representatively referred to as the antenna 34, the high pitched sound speakers 36L and 36R will be representatively referred to as the high pitched sound speaker 36, and the low pitched sound speakers 38L and 38R will be representatively referred to as the low pitched sound speaker 38.

The high pitched sound speaker 36 is a tweeter and suited for outputting high pitched sound, and the low pitched sound speaker 38 is a woofer and suited for outputting low pitched sound. The antenna 32L and the antenna 32R are paired and laterally symmetrical in layout; however, these antennas may have different specifications. Similarly, the antenna 34L and the antenna 34R may have different specifications. Further housed in the main body chassis 14 are a cooling module, a hard disk device and the like, which are not illustrated. Reference numerals 37 in FIG. 2 denote recesses in which the hinges 20 are placed.

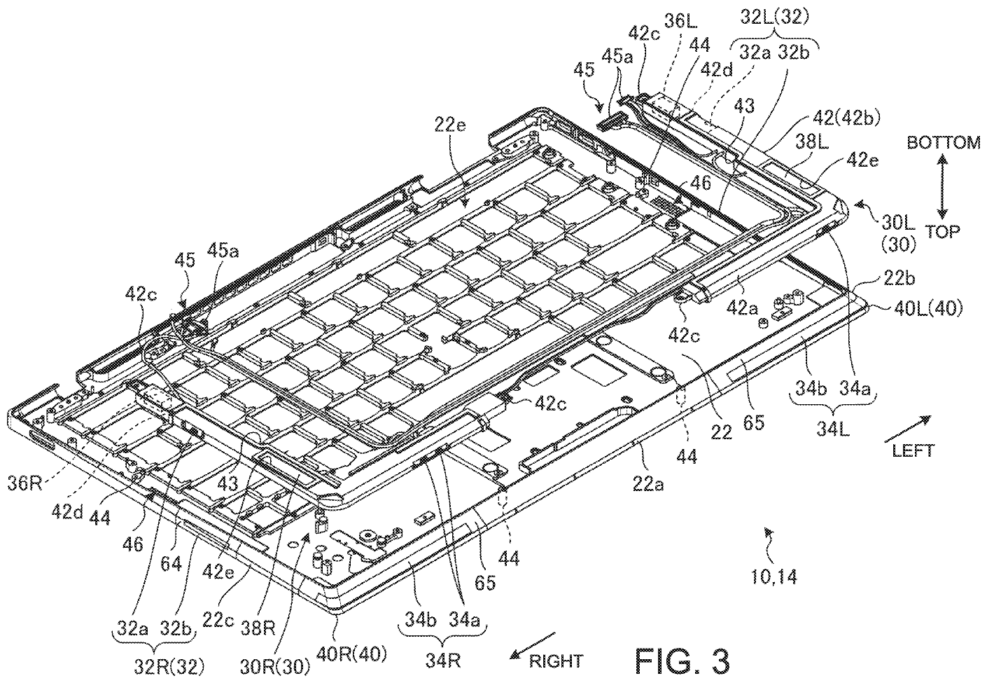

The antenna 32 has a connection terminal 32a provided in the speaker antenna box 30, and an antenna element 32b which includes a side wall 22b or 22c in the upper cover 22 and which is provided along the side wall 22b or 22c. The antenna 34 includes a connection terminal 34a provided in the speaker antenna box 30 and an antenna element 34b which includes a front wall (turn-back plate) 22a of the upper cover 22 and which is provided along the front wall 22a. The majority part of the upper cover 22 and the lower cover 24 is constituted of a radio wave shielding material, such as a metal plate of magnesium or the like or a carbon plate, whereas radio wave transparent sections 64, 65 (refer to FIG. 3) around the antenna elements 32b, 34b are constituted of a radio wave transparent material, such as a resin. The connection terminals 32a, 34a may be provided one each or in a plural number.

In the electronic apparatus 10, the antenna element 34b is provided along the front wall 22a, which is one side that constitutes a corner section 40L or 40R (refer to FIG. 2), and the antenna element 32b is provided along the side wall 22b or 22c, which is the other side that constitutes the corner section 40L or 40R. Thus, the antenna 32 and the antenna 34 can be placed in good balance and appropriately spaced away from each other. In addition, the corner section 40 is effectively used. A part of the antenna element 34b reaches the side wall 22b or 22c.

The electronic circuit board 26 is the motherboard of the electronic apparatus 10. The electronic circuit board 26 is a PCB (printed circuit board) on which various types of electronic components, such as a CPU 26a, a power circuit 26b, and a memory 26c, are mounted.

FIG. 3 is an exploded perspective view illustrating the upper cover 22 and the speaker antenna boxes 30L, 30R viewed from the rear surface side.

The speaker antenna box 30L has a part of the antenna 32L, a part of the antenna 34L, the high pitched sound speaker 36L, and the low pitched sound speaker 38L. The speaker antenna box 30L is provided at a place, which includes the corner section 40L formed by the side wall 22b and the front wall 22a, and has an L-shape along the side wall 22b and the front wall 22a.

The speaker antenna box 30R has a part of the antenna 32R, a part of the antenna 34R, the high pitched sound speaker 36R, and the low pitched sound speaker 38R. The speaker antenna box 30R is provided at a place, which includes the corner section 40R formed by the side wall 22c and the front wall 22a, and is L-shaped along the side wall 22c and the front wall 22a.

The speaker antenna box 30L and the speaker antenna box 30R are substantially laterally symmetrical in structure, so that in the following description, the speaker antenna box 30L will be taken as the example in the drawings.

The speaker antenna box 30 is constituted using an L-shaped box body 42 as its base. The box body 42 is constituted of a first extension section 42a extended along the front wall 22a and a second extension section 42b extended along the side wall 22b. The second extension section 42b is slightly longer than the first extension section 42a. The box body 42 has a mounting piece 42c on each end portion of the first extension section 42a and the second extension section 42b. The mounting pieces 42c are fixed to a boss 44 of the upper cover 22 by screws, which are not illustrated. The speaker antenna box 30 is fixed at a position where the speaker antenna box 30 does not overlap a keyhole group 22e. A stepped section 43 for avoiding the interference with the keyboard device 12 is formed on the second extension section 42b of the speaker antenna box 30.

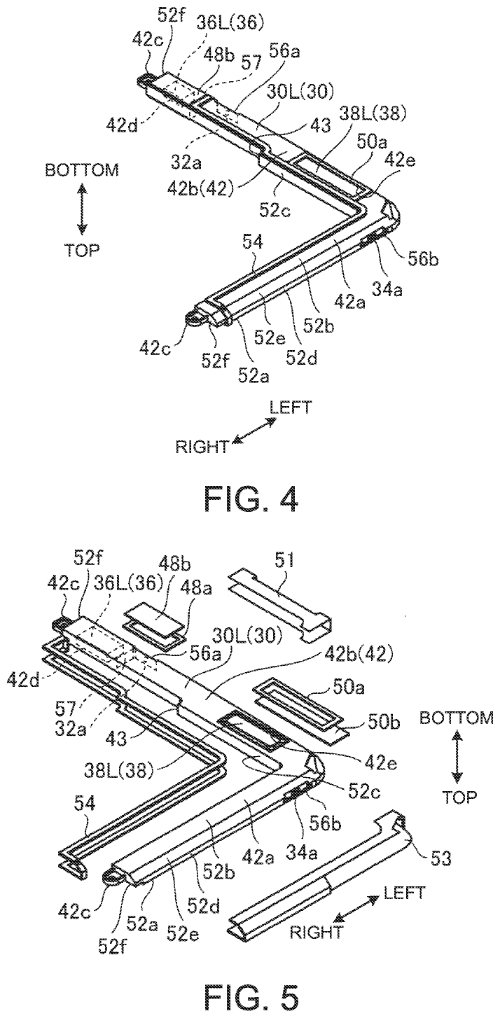

A first speaker hole 42d and a second speaker hole 42e (refer to FIG. 4 and FIG. 5) are formed in the second extension section 42b. The first speaker hole 42d is formed in the lower surface at a location near the L-shaped bent portion in the box body 42, and the second speaker hole 42e is formed in the upper surface at a location near an end portion of the second extension section 42b. The speaker antenna box 30 is provided with a cable 45 for connection with the electronic circuit board 26. The number of connectors 45a at the distal end of the cable 45 is small, e.g., approximately one to four.

FIG. 4 is a perspective view of the speaker antenna box 30, and FIG. 5 is an exploded perspective view of the speaker antenna box 30.

As illustrated in FIG. 4 and FIG. 5, the high pitched sound speaker 36 is provided such that the high pitched sound speaker 36 closes the first speaker hole 42d from the inner side, and the output vibrating body (e.g. a cone) thereof is directed upward. The sound output from the high pitched sound speaker 36 passes through the first speaker hole 42d and further passes through a small hole group 46 (refer to FIG. 1) provided in the upper cover 22. Thus, the sound from the high pitched sound speaker 36 is directly emitted toward a user from the upper surface of the upper cover 22, making it easier to hear. The high pitched sound speaker 36 is relatively close to the display chassis 18, so that the user looking at an image on the display device 16 feels a sense of nearness or a sense of realism.

The low pitched sound speaker 38 is provided such that the low pitched sound speaker 38 closes the second speaker hole 42e from the inner side, and the output vibrating body thereof is directed downward. The sound output from the low pitched sound speaker 38 passes through the second speaker hole 42e and further passes through a small hole group (not illustrated) provided in the lower cover 24. Thus, the sound from the low pitched sound speaker 38 is emitted from the underside of the main body chassis 14. The low pitched sound has low directivity, so that the user can hear the sound well. Further, the output vibrating body of the low pitched sound speaker 38 vibrates at a low frequency and therefore requires an area of a certain size, and the main body chassis 14 requires a hole corresponding thereto; however, the hole is formed in the bottom surface and is not noticeable design-wise.

The first speaker hole 42d is closed by the high pitched sound speaker 36, and the second speaker hole 42e is closed by the low pitched sound speaker 38, thus making the speaker antenna box 30 a hermetically sealed speaker. However, other types, such as a back-loaded horn type or a bass reflex type, may be used, depending on specifications. A vibration absorber or a vibration suppressor made of a resin elastic material, such as rubber, may be placed between the high pitched sound speaker 36 and the low pitched sound speaker 38 and the box body 42. The high pitched sound speaker 36 and the low pitched sound speaker 38 are both constituted by using the space of a part of the box body 42.

In the second extension section 42b, a cushion 48a and a cushion 48b are attached at vertical positions of the high pitched sound speaker 36. The cushion 48a is shaped like a rectangular frame and is provided, surrounding the first speaker hole 42d. The cushion 48b has the same rectangular external shape as that of the cushion 48a, and is provided at the same position as the cushion 48a in a planar view.

In the second extension section 42b, a cushion 50a and a cushion 50b are attached at vertical positions of the low pitched sound speaker 38. The cushion 50a is shaped like a rectangular frame and is provided, surrounding the second speaker hole 42e. The cushion 50b has the same rectangular external shape as that of the cushion 50a, and is provided at the same position as the cushion 50a in a planar view.

The cushions 48a, 48b, 50a and 50b are made of, for example, sponge, polyurethane, PORON (registered trademark), or the like. If the resin foam part of each of the cushions 48a, 48b, 50a and 50b is discretely separated, then the leakage of sound can be prevented. The cushions 48a and 50a are interposed between the box body 42 and the upper cover 22, and the cushions 48b and 50b are interposed between the box body 42 and the lower cover 24, each of the cushions elastically supporting the box body 42. In other words, the box body 42 is supported by the cushions 48a, 48b, the cushions 50a, 50b, and the two mounting pieces 42c. The low pitched sound speaker 38 is provided at the location that is appropriately spaced away from the two mounting pieces 42c, and is therefore supported mainly by the cushions 50a, 50b. Although the low pitched sound speaker 38 outputs low-frequency sounds and the amplitude of the output vibrating body therefore tends to be large, the low pitched sound speaker 38 is placed in a substantially floating state by the cushions 50a, 50b, thus suppressing the transmission of the vibration to the main body chassis 14. Hence, the user does not feel the vibration, and the sound quality is improved.

The box body 42 may be further provided with a cushion 51 and a cushion 53. The cushion 51 covers the three surfaces (the upper surface, the lower surface and the outer surface) of the second extension section 42b between the cushions 48a, 48b and the cushions 50a, 50b. Similarly, the cushion 53 is configured to cover the three surfaces of the first extension section 42a. However, the connection terminals 32a, 34a are to be exposed. In the following description, the cushions 51 and 53 will be omitted.

The box body 42 is shaped like a hermetically sealed box that includes, from the first extension section 42a to the second extension section 42b, a top plate 52a, a bottom plate 52b, an inner plate 52c, an outer plate 52d, and an inclined plate 52e. Further, the end portions of the first extension section 42a and the second extension section 42b are closed by end plates 52f. The mounting pieces 42c are provided on the end plates 52f. The top plate 52a opposes the inner surface of the upper cover 22 and the bottom plate 52b opposes the inner surface of the lower cover 24. The width of the bottom plate 52b is smaller than that of the top plate 52a. The inner plate 52c is an L-shaped plate that closes the inner surface of the box body 42 along the first extension section 42a to the second extension section 42b. Similarly, the outer plate 52d is an L-shaped plate provided on the outer side of the box body 42. The inclined plate 52e is an inclined plate that connects the bottom plate 52b and the outer plate 52d.

The first extension section 42a has a substantially pentagonal section formed by the top plate 52a, the bottom plate 52b, the inner plate 52c, the outer plate 52d, and the inclined plate 52e. However, the first extension section 42a can be said to have a substantially trapezoidal section if the outer plate 52d, which is narrow, is ignored. In the second extension section 42b, the part of connection with the first extension section 42a, i.e. the neighborhood of the L-shaped bent section, has a substantially pentagonal section, and the inclined plate 52e becomes narrower toward the rear, and the rear end portion has a substantially rectangular section formed by the top plate 52a, the bottom plate 52b, the inner plate 52c and the outer plate 52d.

The box body 42 is configured to be hermetically sealed by fixing the top plate 52a by bonding or welding to, for example, a bottomed body with an open top surface, which is composed of the bottom plate 52b, the inner plate 52c, the outer plate 52d and the inclined plate 52e.

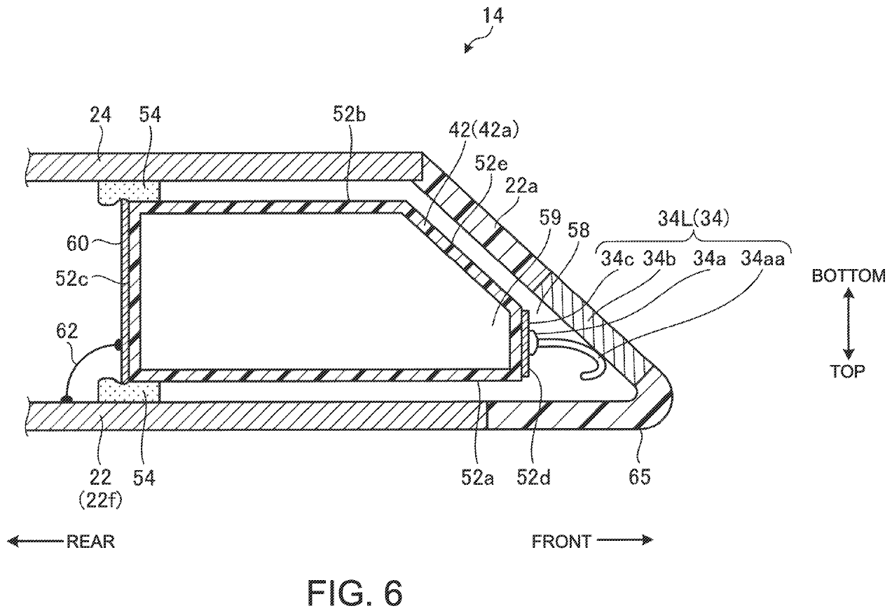

The box body 42 has a shielding member 54 provided along the inner edges of the top plate 52a and the bottom plate 52b, slightly bulging out to the inner side (refer to FIG. 6). The shielding member 54 surrounds also the end plate 52f. The shielding member 54 is formed of a material that can shield electromagnetic wave noises and has flexibility, such as a conductive cushion-like member. A conductive cushion-like member includes, for example, a sponge formed by a material of tin-plated copper or a sponge made by kneading carbon into a resin, such as polyethylene.

The connection terminal 32a is provided in an outer recess 56a in the second extension section 42b, and the connection terminal 34a is provided in an outer recess 56b in the first extension section 42a. The high pitched sound speaker 36 and the connection terminal 32a in the second extension section 42b are partitioned by a partition plate 57. The partition plate 57 separates the high pitched sound speaker 36 and the low pitched sound speaker 38, thus improving sound quality. Depending on the position of the partition plate 57, the second extension section 42b can provide the chamber of the high pitched sound speaker 36.

FIG. 6 is a schematic sectional view of the main body chassis 14 taken along line VI-VI in FIG. 2. As illustrated in FIG. 6, the front wall 22a is a turn-back plate directed downward at an angle from the front edge of the upper cover 22. The front wall 22a inclined as described above provides a sharp impression, which contributes to design effect, and also makes the antenna element 34b provided on the front wall 22a less noticeable. Further, the front wall 22a is configured integrally with an upper surface plate 22f of the upper cover 22, thus making the connection part between the upper cover 22 and the lower cover 24 less noticeable when viewed from above. The area surrounding the antenna element 34b is constituted of the radio wave transparent section 65, thus enabling the antenna element 34b to transmit and receive radio waves over a wide angle range.

The front wall 22a and the inclined plate 52e are substantially parallel to each other, with a small gap provided therebetween. The front wall 22a and the upper surface plate 22f together form a corner section 58 connected at an acute angle. The corner section 58 is an area vertically sandwiched by the upper surface plate 22f and the front wall 22a. In the box body 42, an interposition section 59 is in the corner section 58, the interposition section 59 being composed of the outer plate 52d, substantially the entire inclined plate 52e, and the front edge section of the top plate 52a in the first extension section 42a.

The connection terminal 34a is provided with a metal spring 34aa. The spring 34aa is a leaf spring with a curved hook-shaped distal end, and projects forward, the distal end being in elastic contact with the antenna element 34b. The connection terminal 34a is connected to the electronic circuit board 26 through an antenna board or wiring, which is not illustrated. The outer plate 52d may be provided with an antenna element 34c as a part of the antenna 34. The antenna element 34c is obtained by forming an antenna pattern on the outer plate 52d by, for example, plating or printing. If the antenna element 34c is provided, then the antenna element 34b may be omitted. The spring 34aa may project inward from the antenna element 34b to be in contact with the connection terminal 34a.

In a typical chassis, the space, like the corner section 58, is a dead space, whereas the space in the electronic apparatus 10 is effectively used by a part of the box body 42 being incorporated inside. More specifically, the volume of the internal cavity of the box body 42 can be increased, leading to improved sound quality of the low pitched sound speaker 38. Further, the distance between the connection terminal 34a and the antenna element 34b can be decreased, making it possible to shorten the spring 34aa.

The inner plate 52c of the box body 42 is provided with a shielding section 60. The shielding section 60 is formed as, for example, a conductive metal plate or a plating layer, which uses a material that can shield electromagnetic wave noise. The shielding section 60 is provided on a surface of the box body 42 where there is no antenna, namely, on the inner plate 52c. The shielding section 60 is preferably provided also on the inner edge of the top plate 52a, the inner edge of the bottom plate 52b, and the end plate 52f.

As described above, the shielding member 54 is provided along the inner edges of the top plate 52a and the bottom plate 52b. The shielding member 54 is appropriately compressed between the top plate 52a and the upper surface plate 22f and between the bottom plate 52b and the lower cover 24 to elastically support the box body 42 and to provide electrical conduction between the shielding section 60 and the upper surface plate 22f and the lower cover 24. In other words, the shielding section 60 is grounded.

Hence, the box body 42 is installed inside the main body chassis 14, with the antenna 34 being shielded against electromagnetic waves of an electromagnetic wave generation source, such as the CPU 26a, by the shielding member 54 and the shielding section 60. The shielding section 60 may be connected to the upper surface plate 22f through an auxiliary ground line 62 to enhance grounding.

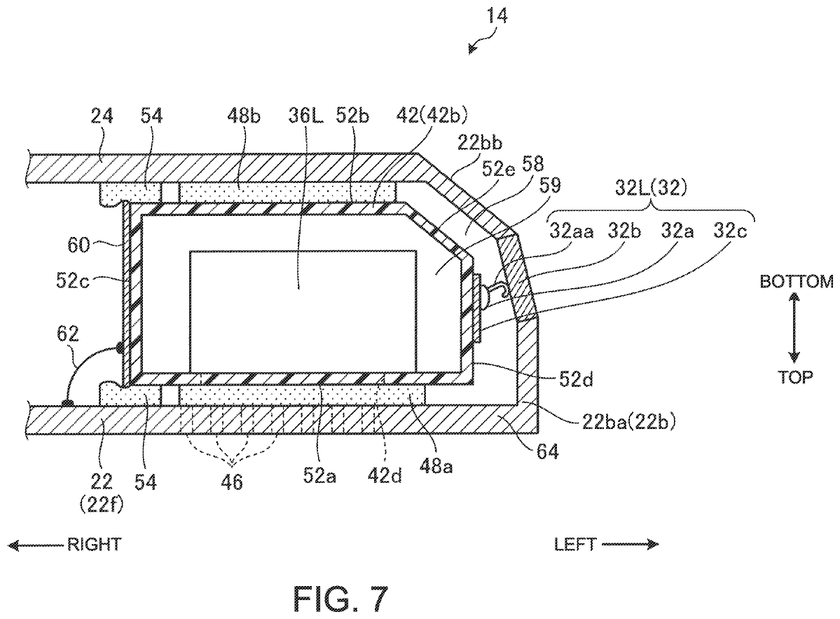

FIG. 7 is a schematic sectional view of the main body chassis 14 taken along line VII-VII in FIG. 2. In FIG. 7, the partition plate 57 is omitted. As illustrated in FIG. 7, the side wall 22b is constituted of a vertical wall 22ba, which is vertically arranged downward from the edge of the upper surface plate 22f, and an inclined wall (turn-back plate) 22bb directed further downward at an angle from the lower edge of the vertical wall 22ba. The antenna element 32b is provided between the vertical wall 22ba and the inclined wall 22bb. The area surrounding the antenna element 32b is constituted of the radio wave transparent section 64, thus enabling the antenna element 32b to transmit and receive radio waves over a wide angle range. The inclined wall 22bb and the inclined plate 52e are substantially parallel to each other, with a small gap provided therebetween.

The connection terminal 32a, a spring 32aa, and the antenna element 32b in FIG. 7 correspond to the connection terminal 34a, the spring 34aa, and the antenna element 34b in FIG. 6 and provide the same effects. Like the antenna element 34c in FIG. 7, the outer plate 52d may be provided with an antenna element 32c.

As illustrated in FIG. 7, the corner section 58 exists between the upper surface plate 22f and the inclined wall 22bb. In the box body 42, the interposition section 59, which is composed of the outer plate 52d, substantially the entire inclined plate 52e, and the front edge section of the top plate 52a in the second extension section 42b, is placed in the corner section 58, thus enabling the effective use of an otherwise dead space. Further, the outer plate 52d and the antenna element 32b are close to each other, thus making it possible to shorten the spring 32aa. As with the first extension section 42a, the shielding section 60 is provided on the inner plate 52c in the second extension section 42b, and the shielding section 60 is electrically connected with the upper surface plate 22f and the lower cover 24 by the shielding member 54, providing an electromagnetic wave shielding effect.

In the second extension section 42b, upper and lower cushions 48a and 48b are provided at the place where the high pitched sound speaker 36 is provided, and are appropriately compressed between the upper surface plate 22f and the lower cover 24. Although not illustrated, upper and lower cushions 50a and 50b are provided at the place where the low pitched sound speaker 38 is provided, and are appropriately compressed between the upper surface plate 22f and the lower cover 24. Thus, the second extension section 42b is properly supported.

In the speaker antenna box 30 of the electronic apparatus 10 configured as described above, the low pitched sound speaker 38 is placed between at least a part of the antenna 32 and at least a part of the antenna 34. Hence, the antenna 32 and the antenna 34 are appropriately spaced away from each other, thus avoiding mutual interference. Further, the low pitched sound speaker 38 provided therebetween includes metal sections, so that the antenna 32 and the antenna 34 are electromagnetically isolated, providing a kind of an isolator. Further, no other device in particular is necessary to isolate the antenna 32 and the antenna 34.

Further, in the speaker antenna box 30, most of the places where the antenna 32 and the antenna 34 are provided are cavities, which function as the back chamber of the low pitched sound speaker 38, thus leading to improved sound quality.

In the speaker antenna box 30, the first extension section 42a extends lengthwise along the antenna element 34b, and the shielding section 60 (refer to FIG. 6) provided on the inner plate 52c acts as the electromagnetic shield against the antenna element 34b. Further, the first extension section 42a is formed to be long to match the antenna element 34b, so that a considerably large back chamber capacity of the low pitched sound speaker 38 can be secured.

The speaker antenna box 30 is L-shaped and is placed along the front wall 22a and the side wall 22b or 22c, so that the corner section 40 is positioned and stabilized.

The speaker antenna box 30 is further provided with the high pitched sound speaker 36. Thus, at least a part of the antenna 32, at least a part of the antenna 34, the high pitched sound speaker 36, and the low pitched sound speaker 38 constitute an integral unit, permitting easy installation to the main body chassis 14. The speaker antenna box 30 can be attached to the main body chassis 14 only by the two mounting pieces 42c. The high pitched sound speaker 36 is provided further toward the rear than the antenna 34 and is near the display chassis 18.

According to the speaker antenna box 30, the antennas 32, 34, the high pitched sound speaker 36 and the low pitched sound speaker 38 are positioned simply by fixing the two mounting pieces 42c to the upper cover 22. This means that the relative positioning between the connection terminal 32a and the antenna element 32b of the antenna 32, between the connection terminal 34a and the antenna element 34b of the antenna 34, between the high pitched sound speaker 36 and the small hole group 46 (refer to FIG. 1), and between the low pitched sound speaker 38 and a low pitched sound output hole (not illustrated) is automatically accomplished. Further, the signal lines of the antennas 32, 34, the high pitched sound speaker 36 and the low pitched sound speaker 38 are converged into the cable 45 (refer to FIG. 3), and the number of the connectors 45a at the distal end of the cable 45 is approximately one to three, thus permitting easy routing of the cable 45 and easy connection to the electronic circuit board 26. These arrangements improve assemblage of the electronic apparatus 10 in the production process.

Depending on specifications, the speaker antenna box 30 may replace the high pitched sound speaker 36 and the low pitched sound speaker 38 by a single speaker capable of outputting sound from low pitched sound to high pitched sound. In this case, the speaker is preferably placed at the position of the low pitched sound speaker 38, i.e., between the antenna 32 and the antenna 34.

Further, the speaker antenna box 30 of the electronic apparatus 10 includes the interposition section 59, which is in the corner section 58, and the interposition section 59 is provided with the connection terminals 32a, 34a. The antenna elements 32b, 34b and the connection terminals 32a, 34a are electrically connected by the springs 32aa, 34aa. Thus, the corner section 58 is effectively used, and the antenna elements 32b, 34b and the connection terminals 32a, 34a can be connected at close positions. The means for electrically connecting the antenna elements 32b, 34b and the connection terminals 32a, 34a are not limited to the springs 32aa, 34aa, and may alternatively be, for example, screws or pogo pins.

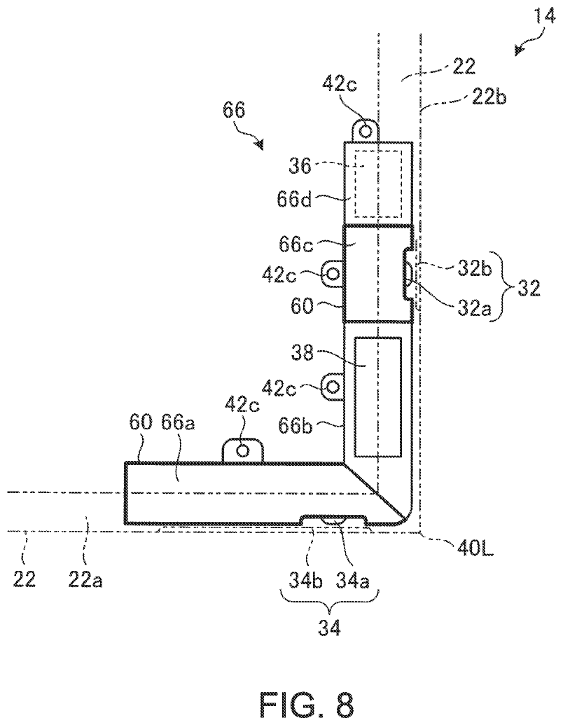

If the prevention of mutual interference between the antenna 32 and the antenna 34 is the purpose, and there is no particular need for the chamber capacity of the low pitched sound speaker 38, then a box group 66 illustrated in FIG. 8 may be used. The box group 66 is provided in place of the speaker antenna box 30, and is constituted of a first box 66a, a second box 66b, a third box 66c, and a fourth box 66d, each of the boxes being independent and attached to the upper cover 22 by the mounting pieces 42c.

The first box 66a corresponds to the above-described first extension section 42a, and is provided with the connection terminal 34a, which is a part of the antenna 34. The second box 66b, the third box 66c, and the fourth box 66d correspond to the above-described second extension section 42b. The second box 66b is provided with the low pitched sound speaker 38, the third box 66c is provided with the connection terminal 32a, which is a part of the antenna 32, and the fourth box 66d is provided with the high pitched sound speaker 36. In this case, the shielding section 60 may be provided at least on the first box 66a and the third box 66c. As with the speaker antenna box 30 described above, the low pitched sound speaker 38 is provided between the antenna 32 and the antenna 34 in the above-described box group 66, so that an appropriate distance is secured, thus suppressing the mutual interference. Further, the antenna 32 and the antenna 34 are electromagnetically isolated by the metal part of the low pitched sound speaker 38.

Obviously, the present invention is not limited to the embodiment described above, and can be freely changed within the scope that does not deviate from the spirit of the present invention.

1. An electronic apparatus comprising:
a chassis;
a box inside the chassis;
a first speaker in a part of a space of the box;
a first antenna formed on an outer surface of the box; and
a second antenna formed on the outer surface of the box;
wherein, in the box, the first speaker is between the first antenna and the second antenna, and thereby provides an electromagnetic shield between the first antenna and the second antenna.

2. The electronic apparatus according to claim 1,
wherein the chassis has a flat shape and has a substantially rectangular shape in a planar view,
the box has a substantially L-shape in a planar view and is at a place that includes a corner section of the chassis,
the first antenna is along a first side that forms the corner section, and
the second antenna is along a second side that forms the corner section.

3. The electronic apparatus according to claim 1, further comprising:
a second speaker for outputting high pitched sound, the second speaker in another part of the space of the box,
wherein the first speaker is for outputting low pitched sound, and
in the box, the first antenna is between the first speaker and the second speaker.

4. The electronic apparatus according to claim 1,
wherein the outer surface of the box, the first antenna and the second antenna are along an outer edge of the chassis, and
a shielding member formed of a material configured to shield electromagnetic wave noise is on an inner surface of the box.

5. The electronic apparatus according to claim 14,
wherein the chassis includes:
a flat plate; and
a turn-back plate which is integrally connected with an end portion of the flat plate and which is inclined inward,
wherein a further part of the box is in a corner section between the flat plate and the turn-back plate.

6. The electronic apparatus according to claim 1, wherein
the chassis has:
a flat plate which constitutes a part of the chassis,
a turn-back plate which is integrally connected with an end portion of the flat plate and which is inclined inward, and
an antenna element which is a part of the first antenna or the second antenna and which is at a place that includes the turn-back plate,
and the area surrounding the antenna element is of a radio wave transparent material.

7. An electronic apparatus comprising:
a chassis;
a speaker on an edge of the chassis;
a first antenna on the edge of the chassis; and
a second antenna on the edge of the chassis,
wherein the speaker is between the first antenna and the second antenna, and thereby provides an electromagnetic shield between the first antenna and the second antenna.

8. An electronic apparatus comprising:
a chassis;
a flat plate constituting a part of the chassis;
a turn-back plate which is integrally connected with an end portion of the flat plate and which is inclined inward; and
an antenna element at a place that includes the turn-back plate,
wherein the area surrounding the antenna element is constituted of a radio wave transparent material.

9. The electronic apparatus according to claim 8, comprising:
a box inside the chassis,
wherein the box has:
an interposition section which is in a corner section between the flat plate and the turn-back plate; and
a connection terminal on the interposition section,
and the antenna element and the connection terminal are electrically connected.
